(19) United States
(12) Patent Application Publication
(10) Pub. No.: US 2022/0340482 A1
(43) Pub. Date: Oct. 27, 2022

(54) Electronic Device Coatings With Organic Components

(71) Applicant: Apple Inc., Cupertino, CA (US)

(72) Inventors: Martin Melcher, Paris (FR); Vijayen S. Veerasamy, Ann Arbor, MI (US)

(21) Appl. No.: 17/697,064

(22) Filed: Mar. 17, 2022

Related U.S. Application Data
(60) Provisional application No. 63/178,674, filed on Apr. 23, 2021.

(51) Int. Cl. C03C 17/245; G02B 5/28

(52) U.S. Cl. CPC C03C 17/245; G02B 5/287

(57) ABSTRACT

An electronic device may have a housing surrounding an interior in which electrical components are mounted. A display may be mounted to housing structures in the device. The housing may have a rear wall. The display cover layer and rear wall of the housing may be formed from transparent glass layers. Coatings may be formed on inwardly and/or facing surfaces of the transparent glass layers. A coating on a transparent glass layer may be formed from one or more PVD layers. A buffer layer that includes a hybrid material with an organic component may be interposed between the glass layer and the PVD layers to increase the retained bend strength of the glass layer. Alternatively or additionally, the PVD layers may form a thin-film interference filter, and some of the PVD layers may be formed from the hybrid material to increase the retained bend strength of the glass layer.

This application claims priority to U.S. provisional patent application No. 63/178,674 filed Apr. 23, 2021, which is hereby incorporated by reference herein in its entirety.

### FIELD

This relates generally to electronic devices and, more particularly, to dielectric films and other electronic device coatings formed from hybrid material with an organic component to increase retained glass strength when the coatings are applied to glass substrates.

### BACKGROUND

Electronic devices such as cellular telephones, computers, watches, and other devices may contain glass structures. For example, electronic devices may have displays in which an array of pixels is covered with a transparent layer of glass. In some devices, a rear housing wall may be covered with a layer of glass. A layer may be applied to the layer of glass to help improve the appearance or physical properties of the rear housing wall, or may be applied to a portion of the transparent layer of glass that covers the display. However, applying these layers to glass may reduce the glass strength of the glass.

It may therefore be desirable to increase the retained glass strength of glass layers to which layers are applied.

### SUMMARY

An electronic device may have a housing in which a display is mounted. The housing may be formed from housing structures that surround an interior region in the electronic device. Electrical components may be mounted in the electronic device interior.

The display may be coupled to the housing structures on a front face of the electronic device. The housing structures may include a rear wall on an opposing rear face of the electronic device.

A display cover layer for the display may have a surface that faces the interior of the housing. The rear wall may also have a surface that faces the interior of the housing. Structures in the electronic device such as the display cover layer and rear housing wall may be formed from transparent glass layers. Coatings may be formed on the inwardly facing surfaces of the transparent glass layers or may be formed on opposing outwardly facing surfaces of the transparent glass layers.

The coatings may include organic components to increase the retained glass strength of the transparent glass layers. The organic components may be in a dielectric layer that is part of a physical vapor deposition (PVD) coating, or may be in a buffer layer between one of the transparent glass layers and a PVD coating.

### BRIEF DESCRIPTION OF THE DRAWINGS

FIG. 1 is a perspective view of an illustrative electronic device in accordance with an embodiment.

FIG. 2 is a cross-sectional side view of an illustrative electronic device having transparent layers forming housing walls in accordance with an embodiment.

FIG. 3 is a cross-sectional side view of an illustrative electronic device having a buffer layer with an organic component and a PVD layer formed on an internal surface of a glass housing layer in accordance with an embodiment.

FIG. 4 is a cross-sectional side view of an illustrative electronic device having a PVD layer with an organic component formed on an internal surface of a glass housing layer in accordance with an embodiment.

FIG. 5 is a cross-sectional side view of an illustrative electronic device having a buffer layer with an organic component and a PVD layer formed on an outer surface of a glass housing layer in accordance with an embodiment.

FIG. 6 is a cross-sectional side view of an illustrative electronic device having a PVD layer with an organic component formed on an outer surface of a glass housing layer in accordance with an embodiment.

FIG. 7 is a diagram of an illustrative process by which a layer with an organic component may be applied to a substrate in accordance with an embodiment.

### DETAILED DESCRIPTION

Electronic devices such as cellular telephones often include glass members such as display cover glass layers and glass housing members. These layers are traditionally coated with materials such as ink. The ink may be opaque to hide internal device components from view, but may not always have a desired appearance. The appearance of glass layers in an electronic device can be altered by depositing inorganic layers such as physical vapor deposition (PVD) layers onto the glass layers. The PVD layers may form thin-film interference filters, for example. Alternatively or additionally, coatings that include thin-film interference filters and ink layers may be applied to the glass layers. In these coatings, thin-film interference filter layers may be arranged to produce non-neutral colors or to produce neutral colors. The thin-film interference filter layers may be coated with ink such as neutrally colored ink or ink with a non-neutral color. Optional buffer layer material may be included in the coatings. In some configurations, thin-film interference layers may be supported by a polymer film and attached to a transparent glass layer using a layer of adhesive.

Challenges arise, however, in ensuring that the glass members on which the coatings are PVD layers are deposited retain sufficient bend strength, as PVD processing reduces the strength of glass. To ensure that the coated glass substrates maintain sufficient bend strength, organic components may be used. In particular, organic components may be incorporated into a buffer layer between a glass substrate and PVD layers, thereby increasing the retained bend strength of the glass substrate. In other words, the buffer layer may be formed from a hybrid material that includes an organic component. Alternatively or additionally, organic components may be incorporated into at least some of the PVD layers to similarly increase the retained bend strength of the glass substrate.

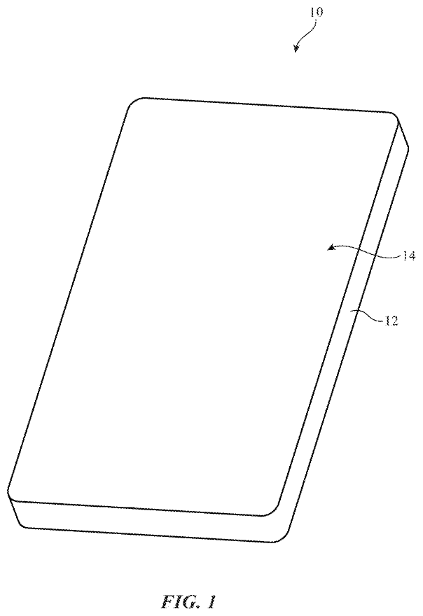

An illustrative electronic device of the type that may have one or more textured glass structures is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, an accessory (e.g., earbuds, a remote control, a wireless trackpad, etc.), or other electronic equipment. In the illustrative configuration of FIG. 1, device 10 is a portable device such as a cellular telephone, media player, tablet computer, or other portable computing device. Other configurations may be used for device 10 if desired. The example of FIG. 1 is merely illustrative.

In the example of FIG. 1, device 10 includes a display such as display 14 mounted in housing 12. Housing 12, which may sometimes be referred to as an enclosure or case, may be formed of plastic, glass, ceramics, fiber composites, metal (e.g., stainless steel, aluminum, titanium, gold, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of pixels formed from liquid crystal display (LCD) components, an array of electrophoretic pixels, an array of plasma pixels, an array of organic light-emitting diode pixels or other light-emitting diodes, an array of electrowetting pixels, or pixels based on other display technologies.

Display 14 may include one or more layers of glass. For example, the outermost layer of display 14, which may sometimes be referred to as a display cover layer, may be formed from a hard transparent material such as glass to help protect display 14 from damage. If desired, the display cover layer may form a front housing wall of housing 12. Other portions of device 10 such as portions of housing 12 and/or other structures may also be formed from glass. For example, walls in housing 12 such as a rear housing wall and/or side walls may be formed from glass.

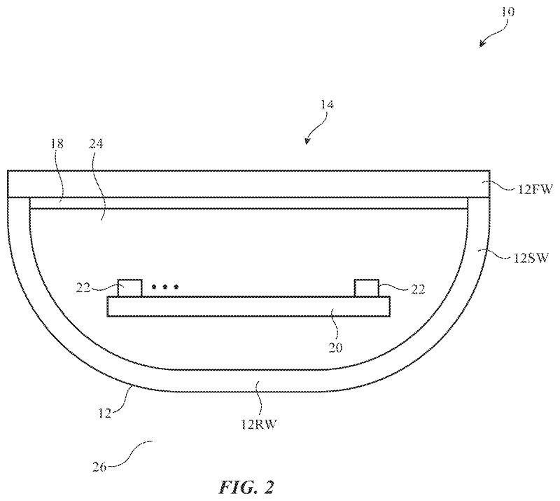

A cross-sectional side view of device 10 is shown in FIG. 2. As shown in FIG. 2, device 10 may have an interior 24 in which electrical components 22 are housed. Electrical components 22 may include integrated circuits, sensors, and other circuitry. As examples, electrical components 22 may form wireless communications circuitry, wireless charging circuitry, processing circuitry, and/or display circuitry, as examples. In general, any desired circuitry may be formed in device 10. Components 22 may be mounted on one or more printed circuits such as printed circuit 20.

As shown in FIG. 2, device 10 may have opposing front and rear faces. Display 14 may be formed on the front face of device 10 (i.e., display 14 may face a front of device 10) and may be covered by a front housing wall 12FW. Housing 12 may have a rear housing wall 12RW on the opposing rear face of device 10. At least portions of one or both of front housing wall 12FW and rear housing wall 12RW may be formed from glass. For example, an entirety of one or both of front housing wall 12FW and rear housing wall 12RW may be formed from glass. However, this is merely illustrative. In general, any desired portion of front housing wall 12FW and/or rear housing wall 12RW may be formed from glass.

Portions of housing 12 may also form sidewalls 12SW for device 10. These sidewall portions of housing 12 may be formed from a material such metal, may be formed from glass, may be formed from the same layer as rear housing wall 12RW, and/or may be formed from the same layer as front housing wall 12FW, as examples. Front housing wall 12FW, rear housing wall 12RW, and/or sidewalls 12SW may be formed from glass, and may specifically be formed from flexible glass, if desired. Some or all of front housing wall 12FW, rear housing wall 12RW, and/or sidewalls 12SW may be curved, while some or all of the walls may be planar, as desired.

Display 14 may include a display cover layer (e.g., a layer of glass) that forms front wall 12FW of housing 12 and may include display module 18 (e.g., display layers that form an array of pixels that present images for a user on the front face of device 10). Display module 18 may be a liquid crystal display structure, an organic light-emitting diode display structure, or other suitable display. During operation, module 18 may present images that are viewable through front housing wall 12FW. The rear of the housing for device 10 may be formed from a glass structure (e.g., rear housing wall 12RW may formed from a glass layer). The thickness of rear housing wall 12RW may be 0.2-5 mm, at least 0.05 mm, at least 0.1 mm, at least 0.2 mm, at least 0.5 mm, at least 0.75 mm, less than 1 mm, less than 2 mm, or other suitable thickness. If desired, a metal plate or other strengthening structures may be laminated to portions of the inner surface of rear housing wall 12RW and/or sidewalls 12SW to enhance the strength of the housing walls.

Inactive border areas in front housing wall 12FW (e.g., areas through which display module 18 does not display images) and portions of other glass structures in device 10 such as some or all of rear housing wall 12RW and/or sidewalls 12SW may be covered with coatings and other structures. In some arrangements, a coating may be used primarily to block light (e.g., to hide internal device structures from view). For example, a coating may be formed on the inner surface of rear housing wall 12RW to hide internal components from view from a user. In other arrangements, a patterned coating may be used to form text, logos, trim, and/or other visible patterns. Coatings that are unpatterned and that coat all of rear housing wall 12RW and/or sidewalls 12SW may also be used to block internal structures from view and/or to provide device 10 with a desired appearance. Patterned coatings may create visible elements and may also block internal structures from view.

Coatings for glass structures in device 10 may be black or other neutral colors or may have non-black (non-neutral) colors (e.g., blue, red, yellow, gold, rose gold, red-violet, pink, etc.). In some configurations, some or all of the coatings for glass structures in device 10 may be shiny (e.g., exhibiting a mirror-like reflective surface with a reflectance of at least 50%, at less 80%, at least 95%, less than 99.99%, or other suitable reflectance).

Coatings on rear housing wall 12RW and/or other glass structures in device 10 may be formed from metals, semiconductors, and/or dielectrics. Dielectric materials for the coatings may include organic materials such as polymer layers and/or inorganic materials such as oxide layers, nitride layers, and/or other inorganic dielectric materials. In arrangements in which a shiny surface is desired, a metal coating with a high reflectivity or a thin-film interference filter with dielectric layers (e.g., a stack of dielectric layers of alternating higher and lower refractive index values) may be configured to serve as a mirror coating (reflective coating). Ink coatings may also be incorporated onto the glass structures, if desired.

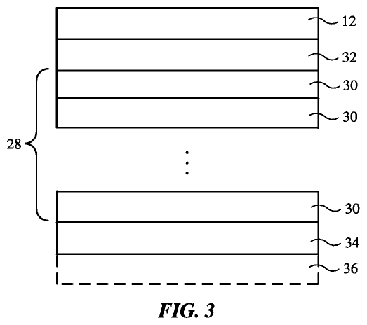

If desired, coatings on transparent housing walls may be PVD coatings. In particular, glass forming rear housing wall 12RW, sidewalls 12SW, and/or front wall 12FW may be coated with PVD layers. These PVD layers may be a plurality of thin-film layers. If desired, the plurality of thin-film layers may form a thin-film interference filter. For example, the PVD layers may be formed on an interior surface of one or more of the glass housing walls to provide the device with a desired appearance, or may be formed on an exterior surface of one or more of the glass housing walls to provide the housing walls with improved physical or optical properties, such as improved strength or anti-reflection capabilities. To maintain the strength of the glass layers on which the PVD layers and/or coatings are applied, hybrid materials having an organic component may be used. An example of using hybrid material with an organic component to improve the retained bend strength of glass substrates is shown in FIG. 3.

FIG. 3 is a cross-sectional side view of an illustrative transparent layer 12, which may be a glass layer. Transparent layer 12 may form at least a portion of one or more of rear housing wall 12RW, sidewalls 12SW, or front housing wall 12FW of FIG. 2. PVD coating 28 may be formed on transparent layer 12. In particular, PVD coating 28 may include thin-film layers 30 (also referred to as dielectric layers 30 herein). PVD coating 28 may include dielectric layers 30 with alternating high and low indices of refraction. For example, PVD coating 28 may include alternating layers of SiO₂ (with a low index of refraction) and Si₃N₄ (with a high index of refraction). However, this is merely illustrative. In general, any high and low index materials may be used. For example, ZrO₂ or Nb₂O₅, may be used for the high index materials. PVD coating 28 may include any desired number of dielectric layers 30. For example, PVD coating 28 may include at least 5, at least 7, 11 or fewer, or at least 10 dielectric layers 30.

As previously discussed, the application of PVD coating 28 on glass layer 12 can reduce the retained bend strength of glass layer 12. To mitigate the loss of retained bend strength in glass layer 12, buffer layer 32 may be applied to glass layer 12 before applying PVD coating 28.

Buffer layer 32 may include organic material. For example, buffer layer 32 may formed from a hybrid material that includes an organic component, such as SiOCH, TiOCH, ZrOCH, or any other desired hybrid material. Incorporating SiOCH (or other hybrid material) in buffer layer 32 may protect glass layer 12 from the PVD coating 28 during PVD processing. In this way, glass layer 12 may have an increased retained bend strength as compared to applying the PVD coating directly onto glass layer 12. For example, glass layer 12 may retain at least 90% of its bend strength after applying PVD coating 28 and buffer layer 32. However, this is merely illustrative. Glass layer 12 may retain at least 92% of its bend strength, at least 95% of its bend strength, or other desired value depending on the thickness and material of buffer layer 32. Buffer layer 32 may include any desired hybrid material. In general, however, buffer layer 32 may have an elastic recovery rate, which is a ratio of the hardness (H) of the layer to an elastic modulus (E) of the layer. In particular, the hardness (H) may be determined as a mean hardness across buffer layer 32, and elastic modulus (E) may be determined as a mean elastic modulus across buffer layer 32. In some embodiments, it may be desirable for buffer layer 32 to have an elastic cover rate of at least 0.1, at least 0.15, at least 0.2, less than 0.5, or other desired rate.

Similarly, buffer layer 32 may have a resistance to plastic deformation given by H³/E³, where H and E are the mean hardness and mean elastic modulus described above. It may be desirable for buffer layer 32 to have a resistance to plastic deformation of at least 0.5, at least 1.0, at least 2.0, between 0.5 and 2.5, or any other desired value.

Moreover, buffer layer 32 may have a coefficient of restitution (COR), which is a measure of how much elastic energy is outputted from the layer when an indentation force that was applied to the layer is relaxed. Buffer layer 32 may have a COR of at least 75%, at least 80%, at least 85%, or other desired value. In this way, buffer layer 32 may retain the original strength of the glass substrate to which it is applied, or even increase the breakage strength of the substrate.

Buffer layer 32 may have a thickness of at least 100 nm, at least 1 micron, 2 microns, less than 2 microns, or at least 1.5 microns, as examples. In general, buffer layer 32 may have any desired thickness to protect glass layer 12 during PVD processing.

Buffer layer 32 may be applied to glass layer 12 using plasma enhanced vapor deposition (PECVD) or any other desired method. Applying buffer layer 32 using a PECVD or other similar method may protect glass layer 12 from the reduced bend strength associated with other methods, such as PVD. Although glass layer 12 is planar in FIG. 3, this is merely illustrative. In general, glass layer 12 may have concave curvature, convex curvature, or may be any other desired shape.

In addition to the inclusion of organic material in buffer layer 32, organic material may be included in PVD coating 28 if desired. For example, one or more of dielectric layers 30 may include organic material or may be formed from hybrid material with an organic component. In one example, each of the low-index layers of PVD coating 28 may be SiOCH layers. In this way, PVD coating 28 may include alternating SiOCH layers and high-index layers (such as Si₃N₄ or other high-index material), which may further increase the retained bend strength of glass layer 12.

Decorative layer 34, which may be an ink layer, for example, may be applied to PVD coating 28. Decorative layer 34 may be an ink layer of any desired color, such as black ink, blue ink, white ink, or any other color. Alternatively, decorative layer 34 may be a metal layer, a metal oxide layer, or any other layer to impart a desired appearance to glass layer 12. Additionally, any number of optional layers 36 may be applied to decorative layer 34. Optional layers 36 may include additional PVD layers, ink layers, metal layers, or any other desired layers.

Buffer layer 32, PVD coating 28, and decorative layer 34 may cover an entirety of one or more of front housing wall 12FW, rear housing wall 12RW, or sidewalls 12SW. Alternatively or additionally, buffer layer 32, PVD coating 28, and decorative layer 34 may cover a portion of one or more of front housing wall 12FW, rear housing wall 12RW, or sidewalls 12SW. For example, buffer layer 32, PVD coating 28, and decorative layer 34 may be used to cover an entirety of rear housing wall 12RW. Alternatively or additionally, buffer layer 32, PVD coating 28, and decorative layer 34 may be applied to a portion of the inactive area of front housing wall 12FW (i.e., a portion of front housing wall 12FW through which display 18 does not display images). However, this is merely illustrative. In general, buffer layer 32, PVD coating 28, and decorative layer 34 may be applied to any desired portion of front housing wall 12FW, rear housing wall 12RW, and/or sidewalls 12SW.

Although FIG. 3 shows the use of decorative layer 34 in combination with PVD coating 28, this is merely illustrative. Decorative layer 34 may be omitted from a portion of or an entirety of PVD coating 28, if desired.

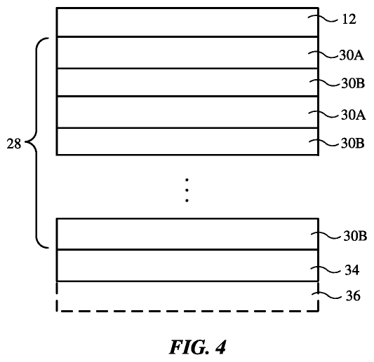

Instead of using a buffer layer, such as buffer layer 32, between a glass layer and a PVD coating, organic material may be incorporated into the PVD coating to improve the retained bend strength of the glass layer. An example is shown in FIG. 4.

As show in FIG. 4, PVD layer 28 may be formed on an inner surface of glass layer 12. Glass layer 12 may form at least a portion of one or more of rear housing wall 12RW, sidewalls 12SW, or front housing wall 12FW of FIG. 2. PVD layer 28 may include dielectric layers of alternating high and low indices of refraction. In particular, PVD layer 28 may include low index layers 30A and high index layers 30B. Low index layers 30A may be formed from a hybrid material that includes an organic component. For example, low index layers 30A may be formed from SiOCH, which has a refractive index of approximately 1.5, TiOCH, ZrOCH, or any other desired hybrid material with an appropriate elastic recovery rate, resistance to plastic deformation, and/or coefficient of restitution, as previously described. High index layers 30B may be formed from Si₃N₄, ZrO₂, Nb₂O₅, or any other desired high index material. Because low index layers 30A are formed from a hybrid material with an organic component, glass layer 12 may have improved bend strength after PVD processing as compared with PVD processing that uses purely inorganic dielectric layers. For example, glass layer 12 may retain at least 90% of its bend strength after applying a PVD coating with layers comprising organic material. However, this is merely illustrative. Glass layer 12 may retain at least 92% of its bend strength, at least 95% of its bend strength, as examples. In this way, PVD coating 28 with layers formed from a hybrid material with an organic component may be formed directly on glass layer 12, if desired. However, a buffer layer between glass layer 12 and PVD coating 28 may additionally be used, if desired.

SiOCH has low absorption. In particular, SiOCH has a k value of less than 10⁻⁴. As a result, the use of SiOCH in PVD coating 28 may allow for increased bend strength retention for glass layer 12 while maintaining the transparency of PVD coating 28.

Although low index layer 30A is shown on glass substrate 12 in FIG. 4, this is merely illustrative. A high index layer 30B may instead be formed on glass layer 12, if desired.

Although low index layers 30A have been described as including hybrid material that has an organic component, high index layers 30B may alternatively or additionally include hybrid material with an organic component, if desired.

Decorative layer 34, which may be an ink layer, for example, may be applied to PVD coating 28. Decorative layer 34 may be an ink layer of any desired color, such as black ink, blue ink, white ink, or any other color. Alternatively, decorative layer 34 may be a metal layer, a metal oxide layer, or any other layer to impart a desired appearance to glass layer 12. Additionally, any number of optional layers 36 may be applied to decorative layer 34. Optional layers 36 may include additional PVD layers, ink layers, metal layers, or any other desired layers.

PVD coating 28 and decorative layer 34 may cover an entirety of one or more of front housing wall 12FW, rear housing wall 12RW, or sidewalls 12SW. Alternatively or additionally, PVD coating 28 and decorative layer 34 may cover a portion of one or more of front housing wall 12FW, rear housing wall 12RW, or sidewalls 12SW. For example, PVD coating 28 and decorative layer 34 may be used to cover an entirety of rear housing wall 12RW. Alternatively or additionally, PVD coating 28 and decorative layer 34 may be applied to a portion of the inactive area of front housing wall 12FW (i.e., a portion of front housing wall 12FW through which display 18 does not display images). However, this is merely illustrative. In general, PVD coating 28 and decorative layer 34 may be applied to any desired portion of front housing wall 12FW, rear housing wall 12RW, and/or sidewalls 12SW.

Although FIG. 4 shows the use of decorative layer 34 in combination with PVD coating 28, this is merely illustrative. Decorative layer 34 may be omitted from a portion of or an entirety of PVD coating 28, if desired.

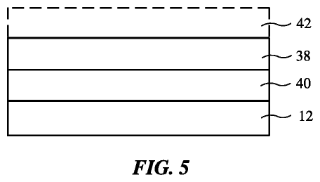

In FIGS. 3 and 4, PVD coating 28 is formed on an interior surface of glass layer 12. By forming PVD coating 28 on the interior of electronic device 10, the appearance of housing 12 may be controlled in part by PVD coating 28, decorative layer 34, and/or optional layers 36. For example, PVD coating 28 may form a thin-film interference filter that affects the reflections of light incident on housing 12 prior to reaching decorative layer 34 and optional layers 36. If desired, however, a PVD coating may be formed on an exterior surface of a glass housing wall. An example of this arrangement is shown in FIG. 5.

As shown in FIG. 5, PVD layer 38 may be formed on an exterior surface of glass housing layer 12. Glass layer 12 may form one or more of rear housing wall 12RW, sidewalls 12SW, or front housing wall 12FW of FIG. 2. In particular, PVD layer 38 may be a hard coating layer. PVD layer 38 may be formed from one or more of SiN, SiON, and AlON, as examples. However, these materials are merely illustrative. Any desired material may be used to form hard coat PVD layer 38.

PVD layer 38 may have a thickness of at least one micron, at least two microns, less than 5 microns, 5 microns, or at least 3 microns, as examples. In general, PVD layer 38 may have any desired thickness.

Because PVD layer 38 is a hard coating on glass layer 12, PVD layer 38 may have a greater adverse effect on the bend strength of glass layer 12 than a softer coating, such as PVD layer 28 of FIG. 3. Therefore, buffer layer 40 may be provided on glass layer 12 between PVD layer 38 and glass layer 12.

Buffer layer 40 may include a hybrid material with an organic component, such as SiOCH TiOCH, ZrOCH, or any other desired hybrid material. If desired, buffer layer 40 may have the same qualities (i.e., elastic recovery rate, resistance to plastic deformation, and/or coefficient of restitution) as buffer layer 32. In this way, glass layer 12 may have increased retained bend strength as compared to applying the PVD coating directly onto glass layer 12. For example, glass layer 12 may retain at least 25% of its bend strength after applying PVD coating 38 and buffer layer 40. However, this is merely illustrative. Glass layer 12 may retain at least 30% of its bend strength, at least 35% of its bend strength, or other desired value depending on the thickness and material of buffer layer 40.

Buffer layer 40 may have a thickness of at least 200 nm, at least 300 nm, at least 500 nm, less than 1 micron, or any other desired thickness. Buffer layer 32 may be applied to glass layer 12 using plasma enhanced vapor deposition (PECVD) or any other desired method. Applying buffer layer 32 using a PECVD or other similar method may protect glass layer 12 from the reduced bend strength associated with other methods, such as PVD. Although glass layer 12 is planar in FIG. 5, this is merely illustrative. In general, glass layer 12 may have concave curvature, convex curvature, or may be any other desired shape.

One or more optional layers 42 may be applied on PVD coating 38, if desired. For example, an oleophobic coating, antireflection coating, or any other desired coating may be formed on PVD coating 38.

Buffer layer 40 and PVD coating 38 may cover an entirety of one or more of front housing wall 12FW, rear housing wall 12RW, or sidewalls 12SW. Alternatively or additionally, buffer layer 40 and PVD coating 38 may cover a portion of one or more of front housing wall 12FW, rear housing wall 12RW, or sidewalls 12SW. For example, buffer layer 40 and PVD coating 38 may be used to cover an entirety of rear housing wall 12RW. Alternatively or additionally, buffer layer 40 and PVD coating 38 may be applied to a portion of the inactive area of front housing wall 12FW (i.e., a portion of front housing wall 12FW through which display 18 does not display images). However, this is merely illustrative. In general, buffer layer 40 and PVD coating 38 may be applied to any desired portion of front housing wall 12FW, rear housing wall 12RW, and/or sidewalls 12SW.

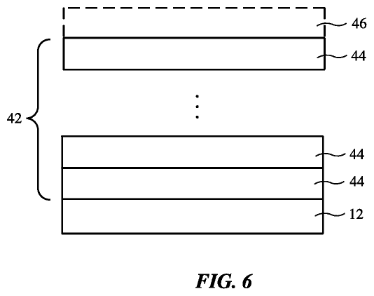

Rather than forming a hard coating, a PVD coating on an exterior surface of housing 12 may form an antireflection coating. An example of this arrangement is shown in FIG. 6.

As shown in FIG. 6, PVD coating 42 may be formed on layer 12. Transparent layer 12 may form one or more of rear housing wall 12RW, sidewalls 12SW, or front housing wall 12FW of FIG. 2 and may be a glass layer. PVD coating 42 may include thin-film layers 44. In particular, PVD coating 42 may include alternating thin-film layers 44 with high and low indices of refraction.

To improve the bend strength of glass layer 12 after applying PVD coating 42, a hybrid material with an organic component may be used as the low index thin-film layers of PVD coating 42. For example, SiOCH, TiOCH, ZrOCH, or any other desired hybrid material may be used to form the low index layers, while Si₃N₄, ZrO₂, Nb₂O₅, or any other desired high index material may be used to form the high index layers. If desired, the low index layers of PVD coating 42 may have the same qualities (i.e., elastic recovery rate, resistance to plastic deformation, and/or coefficient of restitution) as buffer layer 32. However, these materials are merely illustrative. In general, any desired materials may be used to form the thin-film layers of PVD coating 42.

Because the low index layers of PVD coating 42 are formed from a hybrid material with an organic component, glass layer 12 may have improved bend strength after PVD processing as compared with PVD processing that uses purely inorganic dielectric layers. For example, glass layer 12 may retain at least 90% of its bend strength after applying a PVD coating with layers comprising organic material. However, this is merely illustrative. Glass layer 12 may retain at least 92% of its bend strength, at least 95% of its bend strength, as examples. One or more optional layers 46 may be formed on PVD coating 42. Optional layers 46 may include an oleophobic coating, for example. However, this is merely illustrative. In general, optional layers 46 may include any desired coatings.

Although PVD coating 42 has been described as having low index thin-film layers formed from a hybrid material with an organic component, this is merely illustrative. A hybrid material, such as SiOCH, TiOCH, ZrOCH, or any other desired hybrid material may be used to form the high index thin-film layers of PVD coating 42 instead, if desired. Alternatively, different hybrid materials (i.e., hybrid materials with different indices of refraction) may be used to form the high index and low index layers of PVD coating 42.

PVD coating 44 may cover an entirety of one or more of front housing wall 12FW, rear housing wall 12RW, or sidewalls 12SW. Alternatively or additionally, PVD coating 44 may cover a portion of one or more of front housing wall 12FW, rear housing wall 12RW, or sidewalls 12SW. For example, PVD coating 44 may be used to cover an entirety of rear housing wall 12RW. Alternatively or additionally, PVD coating 44 may be applied to a portion of the inactive area of front housing wall 12FW (i.e., a portion of front housing wall 12FW through which display 18 does not display images). However, this is merely illustrative. In general, PVD coating 44 may be applied to any desired portion of front housing wall 12FW, rear housing wall 12RW, and/or sidewalls 12SW.

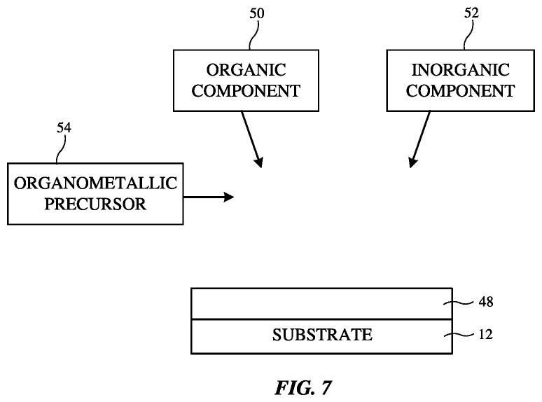

An illustrative diagram showing the process by which a hybrid material that includes an organic component may be applied to a glass substrate is shown in FIG. 7. As shown in FIG. 7, a PECVD process may be used to deposit hybrid coating layer 48 onto glass layer 12. Hybrid coating layer 48 may correspond with buffer layer 34 of FIG. 3, hybrid layer 30A of FIG. 4, buffer layer 40 of FIG. 5, and/or the hybrid thin-film layers of FIG. 6.

As shown in FIG. 7, organic component 50 and inorganic component 52 are used in the PECVD process. Organic component 50 may be an inductively coupled (RF) plasma, while inorganic component 52 may have an inorganic precursor. For example, inorganic component 52 may be silane. Organometallic precursor 54 maybe used, and may be selected from HMDSO, TMDSO, OMCTS, and TMS, as examples. These materials are merely illustrative, however. In general, any desired materials may be used for organic component 50, inorganic component 52, and organometallic precursor 54 to form hybrid coating layer 48.

The foregoing is merely illustrative and various modifications can be made to the described embodiments. The foregoing embodiments may be implemented individually or in any combination.

What is claimed is:

1. An electronic device having an opposing front and rear and an interior, the electronic device comprising:
a display at the front;
a transparent layer that forms a housing wall at the rear, wherein the transparent layer has an inner surface facing the interior and an opposing outer surface; and
a layer on the inner surface comprising a hybrid material with an organic component.

2. The electronic device defined in claim 1 wherein the layer has an elastic recovery rate of at least 0.1.

3. The electronic device defined in claim 2 wherein the layer has a resistance to plastic deformation between 0.5 and 2.5.

4. The electronic device defined in claim 3 wherein the layer has a coefficient of restitution of at least 75%.

5. The electronic device defined in claim 1 wherein the layer is a buffer layer, the electronic device further comprising:
a thin-film interference filter on the buffer layer, wherein the buffer layer is interposed between the thin-film interference filter and the transparent layer.

6. The electronic device defined in claim 5 wherein the transparent layer is a glass layer and wherein the thin-film interference filter is a PVD coating.

7. The electronic device defined in claim 6 wherein the glass layer with the PVD coating has a retained bend strength of at least 90% relative to a bend strength of the glass layer before the PVD coating has been applied.

8. The electronic device defined in claim 7 further comprising:
an ink layer on the thin-film interference filter, wherein the thin-film interference filter is interposed between the ink layer and the buffer layer.

9. The electronic device defined in claim 8 wherein the buffer layer is formed from the hybrid material with the organic component.

10. The electronic device defined in claim 9 wherein the hybrid material with the organic component is selected from the group consisting of: SiOCH, TiOCH, and ZrOCH.

11. The electronic device defined in claim 1 further comprising:
a thin-film interference filter comprising a plurality of thin-film layers, wherein the layer on the inner surface is one of the plurality of thin-film layers.

12. The electronic device defined in claim 11 wherein the transparent layer is a glass layer and wherein the thin-film interference filter is a PVD coating formed directly on the glass layer.

13. The electronic device defined in claim 12 wherein the glass layer with the PVD coating has a retained bend strength of at least 90% relative to a bend strength of the glass layer before the PVD coating has been applied.

14. The electronic device defined in claim 13 wherein the thin-film interference filter comprises alternating layers with high indices of refraction and low indices of refraction.

15. The electronic device defined in claim 14 wherein the layers with the low indices of refraction are formed from the hybrid material with the organic component.

16. The electronic device defined in claim 15 wherein the hybrid material with the organic component is selected from the group consisting of: SiOCH, TiOCH, and ZrOCH.

17. The electronic device defined in claim 16 further comprising:
an ink layer on the thin-film interference filter, wherein the thin-film interference filter is interposed between the ink layer and the glass layer.

18. An electronic device having an interior and an exterior, the electronic device comprising:
a housing including a glass layer, wherein the glass layer has a first surface that faces the exterior and an opposing second surface;
a PVD coating formed over the first surface of the glass layer; and
a buffer layer comprising a hybrid material with an organic component interposed between the glass layer and the PVD coating.

19. The electronic device defined in claim 18 wherein the hybrid material with the organic component is selected from the group consisting of: SiOCH, TiOCH, and ZrOCH.

20. The electronic device defined in claim 19 wherein the PVD coating comprises a material selected from the group consisting of: SiN, SiON, and AlON.

21. An electronic device having an interior and an exterior, the electronic device comprising:
a housing having a glass layer with a surface facing the exterior; and
an antireflection coating on the surface of the glass layer, wherein the antireflection coating comprises a hybrid material with an organic component.

22. The electronic device defined in claim 21 wherein the antireflection coating comprises a plurality of PVD thin-film layers with alternating high and low indices of refraction, and wherein the PVD thin-film layers with the low indices of refraction comprise the hybrid material.

23. The electronic device defined in claim 22 wherein the hybrid material is SiOCH, the electronic device further comprising:
a display, wherein the glass layer of the housing forms a cover glass that overlaps the display.
